(19) United States
(12) Patent Application Publication
(10) Pub. No.: US 2020/0207513 A1
(43) Pub. Date: Jul. 2, 2020

(54) Collapsible Bins and Dumpsters

(71) Applicant: Gehrig Highers, Frisco, TX (US)

(72) Inventor: Gehrig Highers, Frisco, TX (US)

(21) Appl. No.: 16/238,197

(22) Filed: Jan. 2, 2019

(51) Int. Cl. B65D 21/08; B65D 6/24; B65F 1/02

(52) U.S. Cl. CPC B65D 21/086; B65F 2220/106; B65F 1/02; B65D 11/1873

(57) ABSTRACT

The specification describes a collapsible bin for disposal or debris collection that may be assembled from panels and then disassembled to be stored or transported to be used again in another location. The panels of the bin may have a pair of complementary connectors defining apertures of which rods are inserted in the apertures to hingedly connect the panels together. The reusable bin/container/dumpster may be Stormwater Pollution Prevention Plan compliant, light weight, and durable for multiple uses.

### FIELD OF THE INVENTION

Embodiments of the collapsible bins, containers, and dumpsters include a collapsible, reusable bin. The embodiments of the collapsible bins may comprise separable panels. The bins may be collapsible, Stormwater Pollution Prevention Plan (hereinafter, “SWPPP”) compliant, light weight, and durable for multiple uses.

### BACKGROUND

Temporary bins may be used for many purposes. These include residential or commercial construction, structure demolition, commercial or residential remodeling and renovation, debris collection from natural or other destruction, and other uses, for example. Major residential and commercial major builders and their vendors must comply with city, county, and other codes and regulations for on-site trash bins. To comply with these codes and regulations, companies construct one-time use, on-site constructed bins. Each bin costs from about $50 to about $80 in labors and materials.

Major master planned communities may have upwards of 800 to 1000 or more lots for homes to be built and homes in various stages of completion. In some areas, codes and regulations require one bin per home site.

Vendors and builders would save enormous amounts of money every year by purchasing a durable bin that can be moves from site to site as needed. Thus, there is a need for a temporary and/or collapsible bin for repeated use by companies. There is a further need for a bin that may be delivered to a job site, easily constructed on the job site, used to collect and contain trash and other debris, and dismantled for reuse at another location.

There is a need for a collapsible bin that may be simply assembled, used as a storage bin or debris bin, and then disassembled to be compactly stored or easily transported to another location be reused, for example. There is a further need for a bin that may be disassemble and fits on the back of a truck for transport.

### SUMMARY OF THE INVENTION

Embodiments of the invention are directed to a collapsible bin for use as storage or refuse collection for disposal, for example. Embodiments of the collapsible bin comprise multiple interconnecting panels that may be connected to form a bin. The panels may comprise a pair of complementary connectors such that a first connectors on one end of the panel are configured to be able to be connected to a second connector on the opposite end of the panel. Thus, two of the substantially similar panels may be connected end to end using a complementary connector on each panel to form the pair.

One embodiment of the bin comprises six substantially similar interchangeable panels connected by nine rods inserted through apertures defined in connector extensions of the complementary panels on the substantially similar interchangeable panels. In such an embodiment, two of the substantially similar interchangeable panels are connected together to form the bottom of the collapsible bin. Rods are inserted in the apertures of the complementary connectors to hingedly connect the panels together.

Other aspects and features of embodiments of the collapsible bins and the method of constructing a collapsible bin will become apparent to those of ordinary skill in the art, upon reviewing the following description of specific, exemplary embodiments of the present invention in concert with the figures. While features may be discussed relative to certain embodiments and figures, all embodiments can include one or more of the features discussed herein. While one or more embodiments may be discussed herein as having certain advantageous features, each of such features may also be integrated into various other of the embodiments of the invention (except to the extent that such integration is incompatible with other features thereof) discussed herein. In similar fashion, while exemplary embodiments may be discussed below as system or method embodiments it is to be understood that such exemplary embodiments can be implemented in various systems and methods.

### BRIEF DESCRIPTION OF THE DRAWINGS

FIG. 1 depicts a side view of a panel of an embodiment of a bin of the invention;

FIG. 1A depicts a bottom view of the panel of FIG. 1 of an embodiment of the bin of the invention;

FIG. 2 depicts an opposite side view of the panel of FIG. 1 of an embodiment of the bin of the invention;

FIG. 2A depicts a side view of the panel shown in FIG. 2 showing the apertures in the side extensions;

FIG. 3A depicts a perspective view of a locating recess 54 defined in a connector extension 15 of a panel wherein the locating recess 54 wraps around a front edge of the connector extension 15 to facilitate assembly and allow rotation of the panel when incorporated into a bin;

FIG. 3B depicts a plan view of the locating recess 54 of FIG. 3A wherein a retaining recess 56 is defined in the bottom surface of the locating recess 54 to receive a retaining pin on the side and bottom surfaces;

FIG. 3C depicts a cross-sectional view of the locating recess 54 at the centerline of FIG. 3B wherein the locating recess wraps around the end of the front edge of the connector extension 15 and includes three retaining apertures dimensioned to receive a locating pin 55;

FIG. 3D depicts a retaining aperture on the surface of the connecting extension of a panel;

FIG. 4 depicts a perspective view of an embodiment of a bin of the invention constructed from six similar panels hingedly connected by rods through slots;

FIG. 4A depicts an end of an embodiment of the rod 41 wherein the end of the rod defines a female threaded connection and a detachable handle 52, wherein the detachable handle comprises a male threaded connection dimension to be threaded into the female threaded connection;

FIG. 4B depicts a male threaded connection also dimensioned to be threaded into the female threaded connection of an embodiment of rod 42 with a head 52A that may be struck by a hammer to assist in removal of the embodiment of the rod 42 from the apertures of the connection extensions;

FIG. 4C depicts an embodiment of the rod 42 comprising a handle 52B incorporated into the rod 42, the embodiment of the rod 42 depicted has an L-shaped handle;

FIG. 5 depicts a perspective view of an embodiment of a bin of the invention constructed from six similar panels hingedly connected by rods through slots with one side panel in a lowered open position;

FIG. 6 depicts a perspective view of an embodiment of a bin of the invention constructed from six similar panels hingedly connected by rods through slots with one side panel in a swiveled open position;

FIG. 7 depicts perspective view of the embodiment of a bin of FIG. 6 constructed from six similar panels hingedly connected by rods through slots with one side panel in a swiveled open position shown in a disassembled state;

FIG. 8 depicts an embodiment of a panel 80 that may be used as an end panel with tow side panels 10 to assemble a panel of approximately half the volume of the bin 40;

FIG. 9 depicts an embodiment of a cover 44 for an embodiment of a bin, the cover 44 has a perimeter panel 44A to extend the cover around the top perimeter of the bin, bin 40 in FIG. 4, for example, and tie down straps 45 with hooks to connect the cover to rods 42 or other connectors;

FIG. 10 depicts a perspective view of an embodiment of a bottom panel 90 comprising at least one recess trench 91;

FIG. 10A depicts a perspective view of an embodiment of screen or filter that fits within the recess trench 91 of bottom panel 90 shown in FIG. 10; and

FIG. 10B depicts a perspective view of an embodiment of a screen or filter 90B comprising straps that connect to side extensions of the bottom panel.

### DESCRIPTION OF EMBODIMENTS OF THE INVENTION

Collection bins are required to collect and store trash, waste, construction and demolition materials, and other debris (hereinafter “debris”) during construction, renovation, or demolition of residential and commercial structures. The bins should hold the debris to prevent environmental concerns, to retain the debris to prevent it from washing or blowing onto neighboring properties, and to allow for easy removal of the debris from the bin to allow for its proper disposition. Embodiments of the invention comprise a plurality of panels that may be interlocked or connected to form a bin. The bin may typically be a four-sided bin but other configurations are possible. The bin may comprise at least one bottom floor panel.

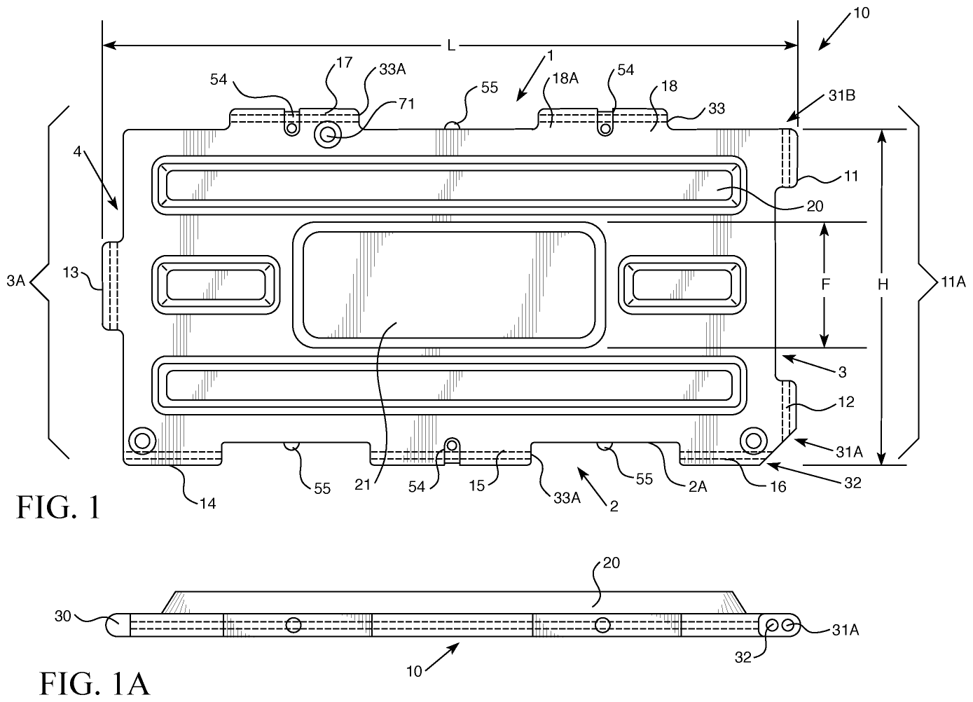

Embodiments of the collapsible bin comprise panels used to construct the sides and/or bottom of the bin, FIG. 1 depicts an embodiment of a panel for constructing the collapsible bin. The panel 10 of FIG. 1 comprises a first pair of complementary connectors on the left and right sides and a second pair of complementary connectors on the top end and the bottom end. As used herein, “complementary connectors” mean a pair of connecting components that cooperate with one another to allow the connection of two panels. The panels may be connected in either in the vertical or horizontal direction. Complementary connectors may include a third component such as a rod, for example, that interacts with the complementary connectors connected to the panel to connect the panels.

The first panel 10 comprises first complementary connector 13A, the first complementary connector 13A comprises a first side extension 13 that defines a first cylindrical aperture 30 on a left side 4 of the panel 10. It should be noted that the panels may be installed in various orientations and, therefore, directional terms such as left side, right side, top e3nd, and bottom end refer to the orientation of the embodiment of the panel as shown in FIG. 1, in other embodiments and orientations of the panel, the labels may be different. Further, the panel 10 comprises a second complementary connector 11A comprising an upper right-side extension 11 that defines an upper right-side second cylindrical aperture 31B and a lower end right-side extension 12 that defines a second cylindrical aperture 31A. A second panel substantially similar to the panel 10 that has at least one complementary connector to either the first complementary connector or the second complementary connector.

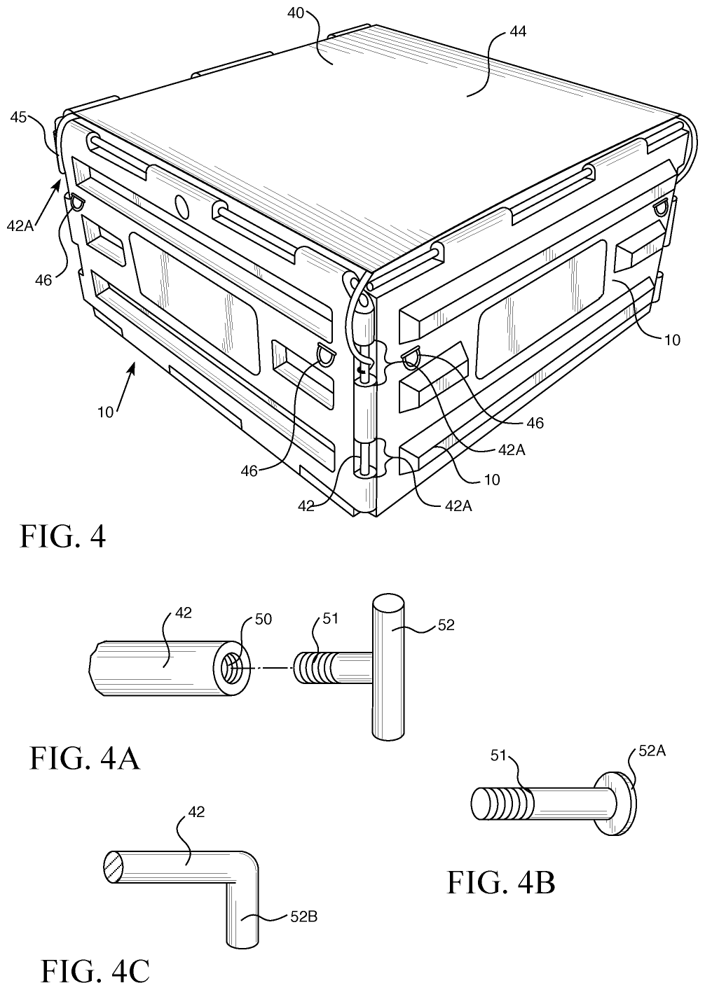

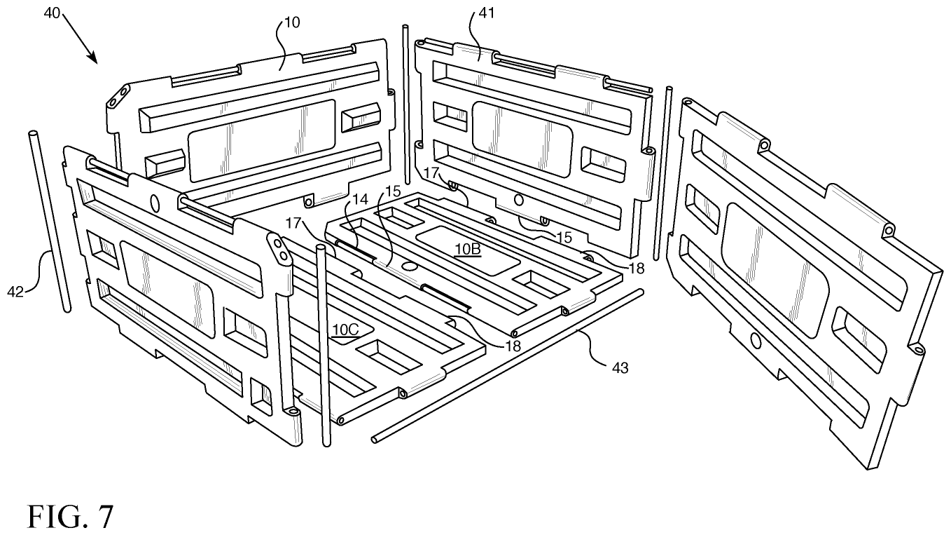

For example, a first complementary connector 13A on a first panel may be positioned to align the first cylindrical aperture 30 with the second cylindrical apertures 31A and 318 of the upper right-side extension 11 and the right-side extension 12. With the apertures aligned, a rod 42 (See FIGS. 4 through 7, for example) may be inserted through the three apertures to provides a hinged connection between the two panels. Additional panels may be similarly connected to produce the bin as shown in FIG. 4.

The embodiment of the bin 40 in FIG. 4 comprises four substantially similar panels 10 hingedly connected by rods 42. The four side panels of the bin (without installed bottom panels) may still have a degree of freedom of movement due to the hinged connections between the panels, so the panels may be formed into a parallelogram, a square, rhombus, or a rectangle. To produce a larger bin, more panels may be connected in a similar manner.

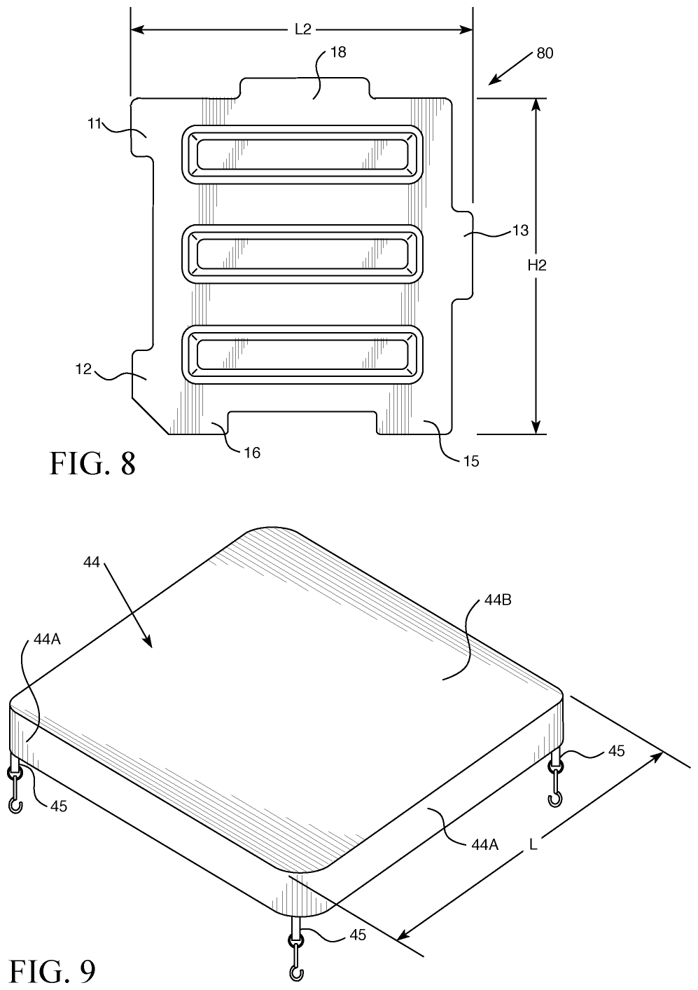

The embodiment of the collapsible bin 40 is approximately eight feet long, eight feet wide and four feet tall. To produce the pin with these dimensions, four panels 10 of FIG. 1 having a length L of eight feet and a height H of four feet may be used. If bottom panels are to be connected to the bin, the height of the inner wall will be the height H of the panel minus the width W1 shown in FIG. 1A. The panels may be dimensioned for the specific application. Another embodiment of the panel 80 is shown in FIG. 8, the panel 80 has a length L2 substantially equal to height H of the panel 10 and a height H2 substantially equal to the height H of the panel 10 such that the panel 80 may be connected on bottom to a panel 10 and to a panel 10 on each side. For example, if the height H is four feet and the length L is eight feet, a rectangular bin may be constructed with two end panels 80 and three panels 10 (a bottom panel and two side panels) having the approximate dimensions of eight feet by four feet. Various size panels may be made but the pairs of the complementary connectors must be dimensioned to connect, align or otherwise allow connection of the panels.

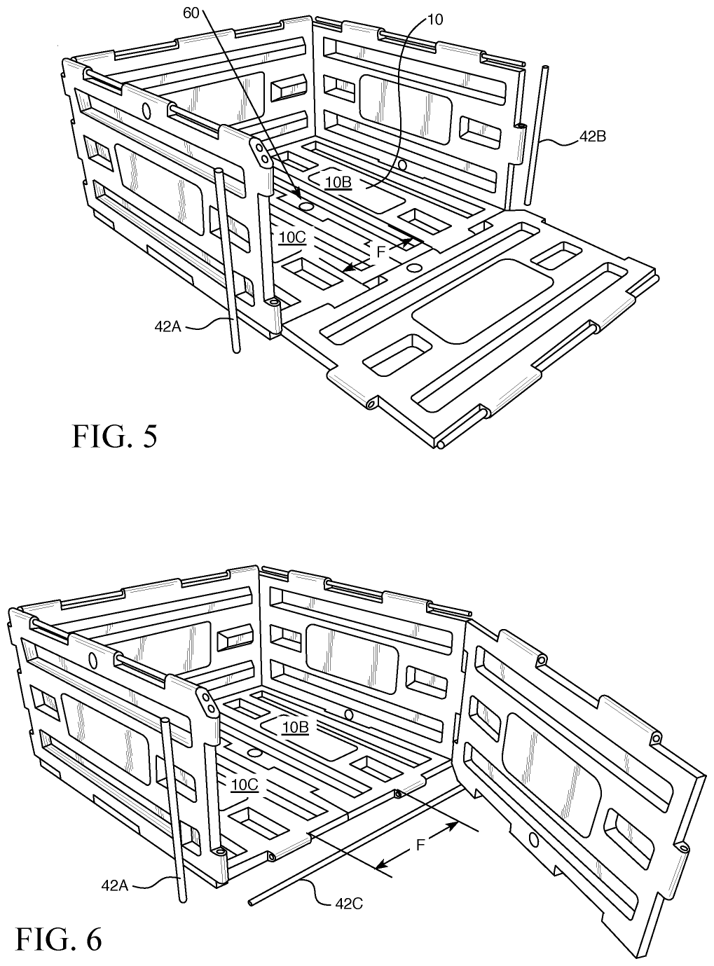

Additionally, the embodiment of the bin shown in FIG. 5 may have two bottom panels 10B 10C forming a bottom 60 surface. The bottom panels 10B (shown on FIGS. 5 and 6) are connected together by a set of complementary connectors along the length L of the panel at the top end of panel 10C is connected to the bottom end of panel 10B.

The bottom panels 10B 10C may comprise feet 20 protruding from the surface of the panel 10. The feet 20 will elevate the bottom panel 10B above the ground. The feet 20 may be designed as ribs along the width or length of the panel or embodiments of the panels may comprise a combination of feet and ribs. The ribs 20 on plastic molded parts help the plastic part such as an embodiment of the panel 10 resist deflection under load or resist warpage. The ribs or feet 20 protrude from one side of the panel 10 in the embodiments shown in the Figures with the opposite side of the panel defining a recess or trough. This provides a rib and structural support to both sides of a hollow panel and allows nesting of the panels, wherein the protruding feet may be received within the recesses or troughs defined in a second panel, to allow more compact stacking of the panels for storage or transport. The angling of the side walls of the feet or ribs allows the compact nesting and stacking.

In other embodiments, the panel may not be hollow and may only comprise ribs or feet 20 that extend from one side of the panel 10 and the opposite side does not define that recesses or troughs. Manufacturing techniques for the sizing, number, dimensions, and locations of the ribs are known in the art.

In the embodiment of the panel 10 of the figures, has feet 20 that run along the length L of the panel 10. The feet 20 have a width W2 that elevates the bottom of the panel 10 to an elevated height of W2 minus W1. In this embodiment of the panel 10, the elevated height is sufficiently high to allow the tines of a fork lift to be inserted below the bottom surface of the panel 10 to allow lifting of a panel, a stack of panels, or an assembled bin by the fork lift.

As shown in FIGS. 5 to 7, embodiments of the collapsible bin may comprise panels 10 to produce a bottom for the bin. In the embodiment, the bottom 60 comprises two similar panels 10B and 10C. Panel 10B is aligned with Panel 10C with four side extension 17 of bottom panel 10C being positioned between first side extension 14 and second side extension 15 of bottom panel 10B and fifth side extension 18 of bottom panel 10C is positioned between a third side extension 16 and second side extension 15 of bottom panel 10B. The panels may then be hingedly connected by pushing a rod 42 through a cylindrical aperture defined in each of the first side extension 14, fifth side extension 18, second side extension 15, fourth side extension 17, and third side extension 16. Alternatively, only one panel 10B may comprise the entire bottom of the bin 40.

In such embodiments, the two end panels 80 (See FIG. 8) may be dimensioned to connect to the height dimension of the panel 10 and only comprise three side extensions, two on one end 11 12 and one on the other end 13. Side panels may then be connected to the bottom panels 108 and 10C as discussed above.

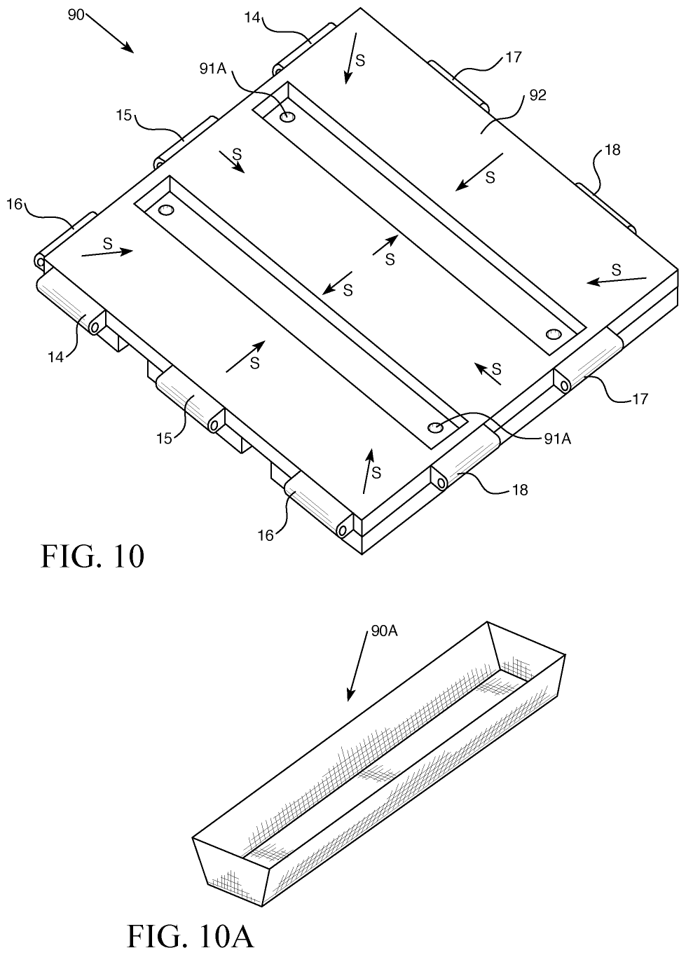

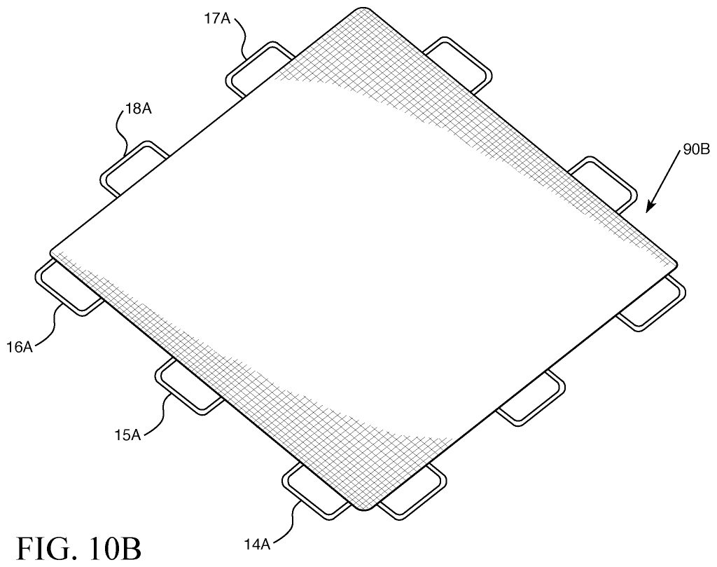

The bottom panel may be a single panel to allow better control of water drainage and collection of debris. A single bottom panel 90 is shown in FIG. 10. The panel is substantially square so that substantially similar panels 10 on each side. The bottom panel 90 has the same connector extensions 14 through 18 defining apertures to receive the rods 42. The bottom panel 90 may have a flat top surface. The flat top may comprise a drain and may be sloped to cause water to flow toward the drain.

In other embodiments, the bottom panel 90 may comprise at least one trench recess 91 defined in the surface of the bottom panel 90. An embodiment of the bottom panel 90 may comprise a single trench recess 91 for collecting water that enters the bin 40. The embodiment of the bottom panel shown in FIG. 10 has two trench recesses 91. The trench recesses 91 are defined by the raised bottom surfaces 92. For an embodiment with only one trench recess 91 there may be only two raised bottom surfaces, for example. In the embodiment shown in FIG. 10, the bottom panel 90 comprises three (3) raised bottom surfaces 92. Many configurations are possible. In certain embodiments, the raised bottom surfaces 92 have a top surface that slope (see arrows labeled S in FIG. 10) toward the recess trenches 91 to collect and drain any water that may enter the bin 40.

The trench recesses may comprise at least one drain 91A. The drain allows water to exit the bin.

In order to prevent debris from exiting the bin with any water, the drains may have screens or filters installed. Because of the amount of dust and dirt that may potentially be washed out of the bin, the bins may comprise reusable or disposable filter. The filters may be cloth, screens or other water permeable material that will not allow solids to pass through. An embodiment of a screen 90A is shown in FIG. 10A. The screen 90A has a complementary shape to the recess 91.

In another embodiment of the screen 90B would cover substantially all or all of the bottom panel 90. The screen 90B may comprise connectors such as loop connectors 14 A, 15A, 16A, 17A, and 18A that may extend over and around the side connectors 14, 15, 16, 17, and 18 of the bottom panel 90 or bottom panels 10A 10B, for example. The screen 90B may be installed as the bin is assembled and removed and properly cleaned when the bin is disassembled.

The bottom panel 90 may be elevated above the ground by feet or cleats or comprise slots to receive tines of a fork lift to allow movement of the bin or the bottom panel by a fork lift, bobcat with tines, a pallet jack, pallet truck or lifter, for example.

Aligning Panels

Embodiments of the bin comprise panels having components that assist in the assembly of the bin 10. The panels may comprise complementary alignment components may be as simple as two flat portions that contact each other in the assembled position. For example, gap 2 between third side connector 16 and second side connector 15 will contact fifth side connector 18 in the assembled position as shown in FIGS. 5, 6 and 7. A flat surface 2A on the inside of the gap 2 on the panel 10 will rest on a flat surface 18A on the inner surface of the fifth side connector 18 in such a position that the cylindrical aperture 33 and cylindrical aperture 33A are aligned with the cylindrical apertures 32 32A and 32B of the first side extension 14, second side extension 15, and third side extension 16. With the apertures aligned, a rod 42 (See FIGS. 4 through 7, for example) may be inserted through the three apertures to provides a hinged connection between the two panels. Each side connector and corresponding gap may comprise flat surfaces or other complementary surface to assist with the assembly of the bin 40 from panels 10.

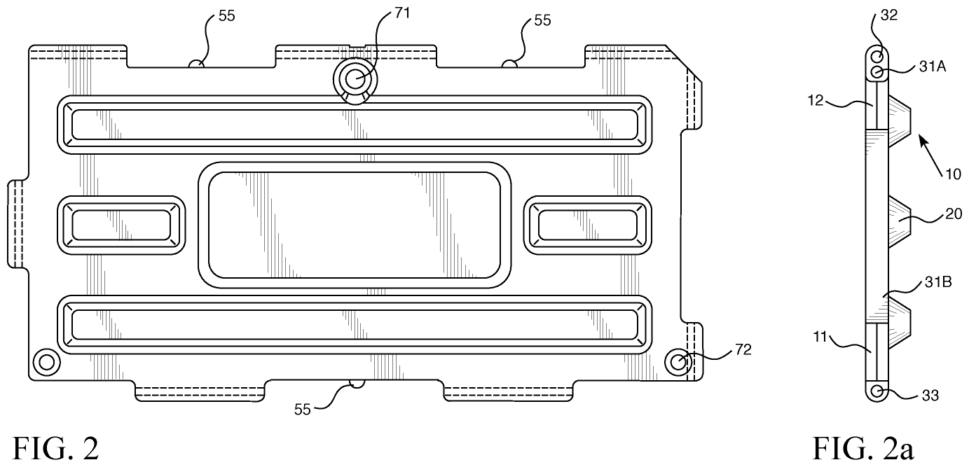

Other or in addition to the corresponding flat surfaces, embodiments of the panels 10 may comprise at least one aligning pin and/or at least one aligning pin recess defined in the wall of the panel. An aligning pin 55 may be a protrusion from at least one of the top end surfaces and the bottom end surfaces. The aligning pin 55 may protrude from the surface between two extensions as shown in FIG. 2, for example. The aligning pin 55 may be inserted into an aligning pin recess 54 of a second panel 10.

Inserting the aligning pin into an aligning pin recess will facilitate locating and retaining the panel in place during assembly of the collapsible bin. The aligning pin and aligning pin recess may be any complementary shapes that allows the aligning pin to be inserted in the aligning pin recess. The aligning pin may be any shape including, but not limited to, cylindrical, cone shaped, hemispherical, three or four sided pyramidal, cross shaped, or a combination of these shapes. In some embodiments, the aligning recess may be a channel. The aligning pin may slide through the channel to allow a hingedly connected panel to rotate around a pin. The bottom surface of the aligning recess may comprise a retaining aperture to retain the panel in a stable position when the aligning pin is received with in the retaining aperture.

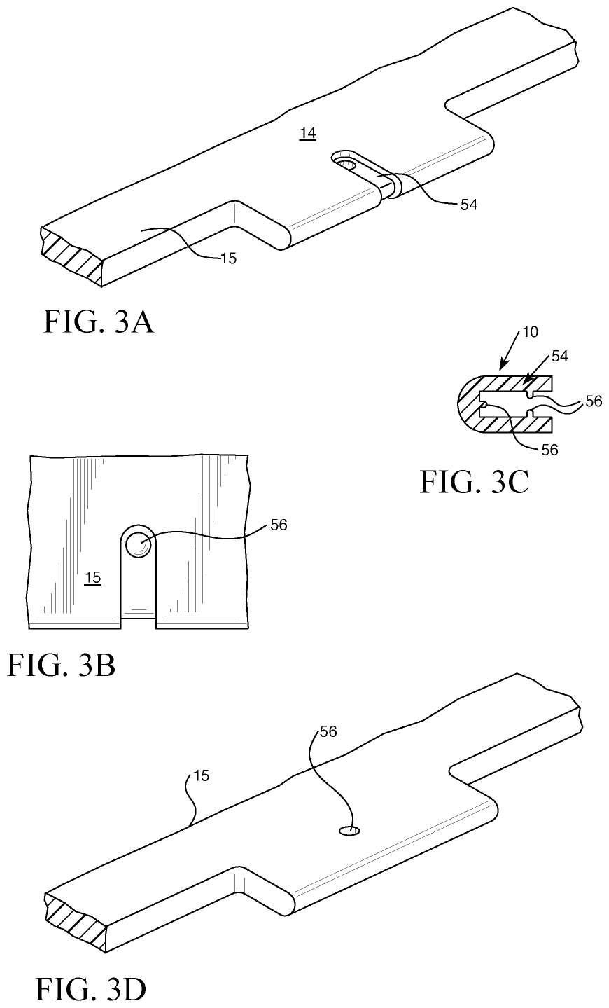

As shown in FIGS. 3A through 3D, the aligning pin recess 54 may further include a retaining aperture 56. During assembly of the bin, the bottom 60 may be assembled initially by connecting panel 108 to panel 10C with a rod 42. A further panel 10 may then be lifted and positioned substantially perpendicular (or in some cases parallel) to either or both bottom panels 10B 10C. In embodiments having an aligning pin 55 and an aligning pin recess 54, the aligning pin 55 may be inserted into aligning pin recess 54 to assist in aligning panel 10 with either or both panels 10B 10C. Further, the aligning pin 54 may be inserted in retaining aperture 56 defined in the bottom surface of the aligning pin recess 54. With the aligning pin 54 in the retaining aperture 56 will assist in maintaining the panel 10 in substantially perpendicular (or substantially parallel) position relative to the bottom 60 while the rod 42 is inserted in the cylindrical apertures. The aligning pin 55 when inserted in the retaining aperture will cause the panel to resist movement from either its “retained” position. In the embodiment shown in FIG. 3C, the aligning pin recess 54 and three retaining apertures 56 is defined in the panel within the aligning pin recess 54. The three pictured retaining apertures 56 will support a panel 10 in either a parallel position or a perpendicular position to the other panel 10. In other embodiments, the retaining apertures 56 may be defined in the aligning pin recess 54 or in the panel 10 to retain the panel 10 in other positions relative to a second panel.

Cover

Embodiments of the bin may comprise a cover. The cover may be installed over the bin to prevent rain from entering the bin. Water in the bin may be absorbed into debris such as dry wall, for example to increase the weight and, therefore, the disposal cost of the debris. Further, water may wash debris and construction chemicals out of the bin.

An embodiment of the debris bin 40 may comprise a cover 44 such as a tarp or other water impermeable sheet. The water impermeable sheet 44 may be plastic or rubber sheet, for example. Embodiment of a cover 44 for the bin 40 are shown in FIGS. 4 and 9. The cover 44 may extend beyond the edges of the bin 40 and therefore will have a length longer than the length L of the panel 10. The cover 44 may further comprise tie down straps 45. The tie down straps 45 may connect to a strap connector 46, for example. The strap connector 46 may be a u-shaped connector (as shown in FIG. 4), an eye bolt, a hook, carabiner, post, or other connector type compatible with the tie down strap 45. In another embodiment, the tie down strap 45 may be connected to the rod 42 in the exposed gap 42A between connection extensions. The exposed gap 42A may also be used to grasp the rod 42 for inserting the rod or removing the rod from the panels.

Another embodiment of the cover is shown in FIG. 9, the cover 44 comprises a top panel 448 and a perimeter panel 44A extending down from the top panel 448 on all four sides. The tie down straps 45 may be connected to the bottom of the corners of the perimeter panels 44A. The tie downs 45 may then be connected to the strap connectors 46 or to the rods exposed in the exposed gap 42A as discussed above.

In order to add weight and stability to the bin, specific embodiments of the bin 10 be filled with water or other liquid. The panels may be filled either before or after assembly. A water filled bin will be more able to withstand damage from filling or emptying operations and will be able withstand high winds and withstand deflections under load.

For example, a panel 10 as shown in FIG. 1 comprises a first end water connector 71 and a second end water connector 72. Either of the first water connector 71 and the second water connector 72 may be used to add water to an inner volume of the panel, drain water from the inner volume of the panel, or allow air to enter or leave the inner volume during filling or draining operations. One or more of the panels 10 of a bin 40 may be filled with water. For example, the bottom panels 10B 10C may or may not be filled with water. Further, if one of the panels is to be used as a door, that panel 10 may not be filled with water or may be drained prior to opening.

The panels 10 may be filled from the bottom or the top. The air, however, in the inner volume must be vented from the top to allow the water to fill the inner volume. Therefore, a water hose may be connected to second end water connector 72 and a first end water connector 71 or air vent may be opened to allow the air to vent as the water is added.

Any of the first end water connector 71 and/or the second end water connector 72 may be closed by a cap, the cap may snap on or screwed on, for example, or the first end water connector 71 and/or the second end water connector may have a valve installed to facilitate water addition or removal. The connectors may be typical hose threaded connectors, for example.

Further, to facilitate adding water to multiple panels simultaneously, the panels may be connected together by hose segments. Two water connectors 71 and/or 72 of different panels may be connected to allow water to flow to both panels simultaneously.

Embodiments of the bins may also be personalized with builder or vendor names and logos as well as any pertinent SWPPP notifications or OSHA safety requirements for job site work. In such embodiments, the panel 10 may comprise a flat surface 21.

The bin could also be utilized by individual home owners for storage of items such as, but not limited to, toys, books, decorations, and clothes, for example, or trash at their homes and may, therefore, be dimensioned for various applications. Embodiments of the bin may be dimensioned to be stored in a garage and have a wide array of uses.

Embodiments of the panels 10 may be made of injection molded plastic similar to road barricades, food crates, or children's play sets for long term durability and ease of movement/storage. The panels may be solid or comprise in an inner volume. The inner volume may be accessible for filing with water, other liquid or a solid such as, but not limited to sand. The solid panels may be a sheet of plywood with the extension connected to the plywood or cut into the plywood or a plastic sheet, for example.

The embodiments of the described bin and method are not limited to the particular embodiments, components, method steps, and materials disclosed herein as such components, process steps, and materials may vary. Moreover, the terminology employed herein is used for the purpose of describing exemplary embodiments only and the terminology is not intended to be limiting since the scope of the various embodiments of the present invention will be limited only by the appended claims and equivalents thereof.

Therefore, while embodiments of the invention are described with reference to exemplary embodiments, those skilled in the art will understand that variations and modifications can be affected within the scope of the invention as defined in the appended claims. Accordingly, the scope of the various embodiments of the present invention should not be limited to the above discussed embodiments and should only be defined by the following claims and all equivalents.

1. A collapsible bin, comprising:
a plurality of interchangeable panels, wherein each of the interchangeable panels comprise:
a top end, a bottom end, a left end and a right end and a left end; wherein one of the top end and the bottom end comprise at least two connection extensions and the other of the top end and the bottom end comprise at least one connection extension and one of the left end and the right end comprise at least two connection extensions and the other of the left end and the right end comprise at least one connection extension; wherein each connection extension defines a through hole;
a bottom comprising at least one first interchangeable panel;
a first side wall comprising a second interchangeable panel, wherein the top end of the first interchangeable panel is adjacent to the bottom end of the second interchangeable panel and a first rod is received within an aperture defined in the connection extension of the first interchangeable panel and a cylindrical aperture in each of the two connection extensions of the second interchangeable panel to connect the first interchangeable panel and second interchangeable panel;
a second side wall comprising a third interchangeable panel, wherein the left end of the first interchangeable panel is adjacent to the bottom end of the third interchangeable panel and a second rod is received within an aperture defined in the connection extension of the left end of the first interchangeable panel and a cylindrical aperture an aperture of the connection extension on the bottom end of the third interchangeable panel to connect the first interchangeable panel and third interchangeable panel and wherein the left end of the second interchangeable panel is adjacent to the right end of the third interchangeable panel and a third rod is received within an aperture defined in the connection extension of the left end of the second interchangeable panel and a cylindrical aperture an aperture of the connection extension on the right end of the third interchangeable panel to connect the second interchangeable panel and third interchangeable panel.

2. The collapsible bin of claim 1, wherein the bottom further comprises a fourth interchangeable panel, wherein the bottom end of the first interchangeable panel is adjacent to the top end of the fourth interchangeable panel and a third rod is received within an aperture defined in the connection extension of the bottom end of the first interchangeable panel and a cylindrical aperture an aperture of the connection extension on the top end of the fourth interchangeable panel to connect the first interchangeable panel and fourth interchangeable panel and wherein the left end of the fourth interchangeable panel is adjacent to the bottom end of the third interchangeable panel and the third rod is received within and aperture defined in the connection extension of the left end of the fourth interchangeable panel and a cylindrical aperture an aperture of the connection extension on the bottom end of the third interchangeable panel to connect the fourth interchangeable panel and third interchangeable panel.

3. The collapsible bin of claim 2, wherein at least one of the third interchangeable panels has at least one water connector near one of the top end or the bottom end and at least one air vent at the other of the top end and the bottom end.

4. The collapsible bin of claim 3, wherein the air vent is also a water connector.

5. The collapsible bin of claim 4, wherein the water connectors are water hose connectors.

6. The collapsible bin of claim 1, wherein the first interchangeable panel defines a pin aligning pin recess in the top end of the first interchangeable panel and the second interchangeable panel comprises an aligning pin protruding from the bottom end of the second retaining panel and the aligning pin is received within the locating recess.

7. The collapsible bin of claim 6, wherein a retaining recess is defined in the locating recess and the aligning pin is received within the retaining recess.

8. The collapsible bin of claim 1, wherein the rod has a female threaded connector on an end of the rod.

9. The collapsible bin of claim 8, wherein the rod has a female threaded connector on both ends of the rod.

10. A collapsible bin, comprising:
six substantially similar interchangeable panels connected together by nine rods threaded through apertures defined in connector extensions on the substantially similar interchangeable panels.

11. The collapsible bin of claim 10, wherein at least three of the substantially similar interchangeable panels are filled with water.

12. The collapsible bin of claim 10, wherein two of the substantially similar interchangeable panels form the bottom of the collapsible bin.

13. The collapsible bin of claim 10, wherein the six rods have a female threaded connector on each end of the rod.
